(19) United States
(12) Patent Application Publication
(10) Pub. No.: US 2026/0033605 A1
(43) Pub. Date: Feb. 5, 2026

(54) Orthopedic Walking Boot Mobility Aid Accessory

(71) Applicant: Aaron Peterson, Ariel, WA (US)

(72) Inventor: Aaron Peterson, Ariel, WA (US)

(21) Appl. No.: 19/074,941

(22) Filed: Mar. 10, 2025

Related U.S. Application Data
(60) Provisional application No. 63/676,988, filed on Jul. 30, 2024.

(51) Int. Cl. A45B 3/00; A43B 3/02; A45B 9/00; A45B 9/02; A61H 3/00

(52) U.S. Cl. CPC A45B 3/00; A43B 3/02; A45B 9/02; A61H 3/00; A45B 2009/007; A61H 2003/007; A61H 2201/0165; A61H 2201/1269; A61H 2201/1642; A61H 2230/80

(57) ABSTRACT

An air or walking boot accessory to enhance mobility and independence for individuals using orthopedic walking boots is disclosed. The accessory integrates with or removably attaches to conventional orthopedic or walking boots. The accessory includes a telescoping cane or pole having a plurality of apertures, an ergonomic handle, and an air shock relief member. A cane receiving member accommodates the cane and includes a spring button locking mechanism for secure height adjustment of the cane. In some embodiments, a forearm support crutch can be accommodated in the cane receiving member. A clip member securely attaches the device to the boot, while a slip-resistant cylindrical member enhances stability. Additionally, the device includes a dial weight indicator with a calibration mechanism to monitor and display the applied weight, ensuring users adhere to doctor-prescribed weight-bearing limits. A user can walk with support from the cane or other supporting member.

### CROSS-REFERENCE TO RELATED APPLICATION

The present application claims priority to, and the benefit of, U.S. Provisional Application No. 63/676,988 which was filed on Jul. 30, 2024, and is incorporated herein by reference in its entirety.

### FIELD OF THE INVENTION

The present invention generally relates to mobility aids for individuals with lower limb injuries. More specifically, the invention relates to a crutch-free air boot accessory designed to enhance user mobility, comfort, and recovery. The device integrates with existing orthopedic walking boots and includes a cane or pole receiving member that securely attaches to the boot using a pivoting clip mechanism. A cane/pole features a telescoping design with adjustable height, an ergonomic handle, and a spring button locking mechanism secures the cane to the cane receiving member. Additionally, the device incorporates a dial weight indicator and an air shock relief member with a pressure gauge, enabling users to monitor and regulate the weight applied on the cane or pole according to doctor-prescribed limits. Accordingly, the present disclosure makes specific reference thereto. Nonetheless, it is to be appreciated that aspects of the present invention are also equally applicable to other like applications, devices, and methods of manufacture.

### BACKGROUND

By way of background, individuals who experience injuries such as sprains or fractures to the foot, ankle, or lower leg often rely on crutches to maintain mobility during the healing process. While crutches are a common mobility aid, they present several challenges and limitations that can impede recovery and reduce the quality of life for users. Firstly, crutches can be difficult to use, especially for individuals lacking upper body strength or coordination. The operation of crutches requires significant arm, shoulder, and core muscle engagement to support body weight and facilitate movement. Prolonged use often leads to discomfort, aches, and pains in the underarm area, shoulders, and upper body due to constant pressure and repetitive motions. This discomfort can discourage consistent use, potentially hindering the rehabilitation process.

Secondly, with crutches, it is challenging for users to accurately gauge and control the weight distribution between their arms and the injured leg. Overloading the injured limb can exacerbate the injury or delay healing, while under-loading may result in muscle atrophy or decreased bone density due to insufficient stress on the limb. Effective weight regulation is essential to promote proper recovery and rehabilitation. Additionally, the use of crutches occupies both hands, limiting the user's ability to perform everyday tasks that require manual dexterity. Simple activities such as carrying objects, opening doors, or handling personal items become cumbersome or impossible without assistance. Many individuals use orthopedic walking boots, however, with boots, crutches are required by individuals in order to walk. Individuals desire an improved mobility aid that addresses the shortcomings of traditional crutches and which eliminates use of crutches with walking boots.

Therefore, there exists a long-felt need in the art for a mobility aid that eliminates the challenges and discomfort associated with traditional crutches. Specifically, there is a long-felt need for a device that reduces the strain and pain in the upper body and underarm areas caused by crutch use. Additionally, there is a need for a mobility solution that enables for precise weight regulation on an injured limb. Furthermore, there exists a long-felt need for a device that enables users to retain at least one free hand, enabling them to carry items or perform daily tasks with greater case. Also, there is a long-felt need in the art for a walking boot attachment device that replaces crutches and provides a much more efficient and effective support for individuals with injured extremities. Finally, there is a need for a mobility aid that integrates with existing orthopedic walking boots, enhances stability and user confidence while minimizing the risk of additional injuries during recovery.

The subject matter disclosed and claimed herein, in one embodiment, comprises a crutch-free air boot accessory. The device includes a cane receiving member that integrates with or removably attaches to a conventional orthopedic walking boot using a secure clip mechanism. The cane or pole features a telescoping design with adjustable height, enabling users to customize the device for ergonomic use. A spring button locking mechanism in the cane receiving member secures the cane at the desired height. Furthermore, the device incorporates a dial weight indicator, enabling users to monitor and regulate the weight applied to the cane, adhering to doctor-prescribed weight-bearing limits. The modular design accommodates various attachments, including crutch-style handles and forearm supports, catering to the specific needs of different users.

In this manner, the crutch-free air boot accessory of the present invention fulfills the aforementioned needs by providing a solution for mobility and support during recovery. The device offers users a walking boot and cane (i.e., pole) attachment that utilizes a pivoting point of connection to accommodate a rigid, height-adjustable cane, ensuring ergonomic use and stability. The cane includes a dial that identifies the amount of weight being applied, enabling users to adhere to prescribed weight-bearing requirements. The accessory supports multiple attachments, such as a weight sensor and an adjustable rotating crutch handle, catering to diverse user needs. By replacing traditional crutches, this accessory provides a more efficient, effective, and user-friendly support system for individuals with injured extremities.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an air boot accessory for enhancing user mobility. The accessory comprises a cane receiving member, a clip member connected to the cane receiving member, the clip member is configured to securely attach the air boot accessory to the orthopedic walking boot, a telescoping cane has a top end and a bottom end, the cane is configured to be received within the cane receiving member, the cane including a plurality of apertures along its length, and a spring button locking member is disposed near a top portion of the cane receiving member, the locking member engages with at least one aperture of the cane to lock the cane at a user-defined height.

In another aspect, an air boot accessory for user mobility and weight distribution monitoring is disclosed. The air boot accessory includes a cane receiving member configured to attach to an orthopedic walking boot, a telescoping cane with adjustable height is received within the cane receiving member, the cane has a handle at its top end for ergonomic use. A clip member is configured to securely attach the cane receiving member to the walking boot. A dial weight indicator is integrated into the cane receiving member, the indicator is configured to measure and display the weight applied by the user on the cane, wherein the dial weight indicator enables users to compare the applied weight with a weight threshold corresponding to doctor-prescribed limits.

In one embodiment, an orthopedic walking boot accessory for mobility aid is disclosed. The accessory includes a cane receiving member made of a lightweight and durable material, configured to be attached to an orthopedic walking boot using a clip member, a rotating forearm support is attachable to the cane receiving member for users desiring additional elbow support, a dial weight indicator is integrated into the cane receiving member, configured to display the weight applied by the user on the cane, a pivoting joint enables the forearm support to rotate, the weight is applied through the forearm support measurable via the dial weight indicator.

In yet another aspect, a mobility accessory device for use with an orthopedic walking boot is disclosed. The device includes a cane receiving member configured for removable attachment to the walking boot using a clip mechanism, a telescoping cane having a top ergonomic handle and a bottom end, the cane is lockable at a user-defined height using a spring button locking mechanism within the cane receiving member, an air shock relief member for reducing impact during movement, and a weight calibration mechanism comprising a dial weight indicator and a gauge needle for setting and monitoring applied weight on the canc.

In still another embodiment, the cane receiving member further comprises a slip-resistant cylindrical member circumscribing at least a portion of the cane receiving member, the slip-resistant cylindrical member configured to enhance stability during use.

In yet another embodiment, the calibration mechanism of the dial weight indicator includes a rotating adjustment dial and a gauge needle, the rotating adjustment dial enabling the user or a medical professional to set a weight threshold, and the gauge needle visually displaying the applied weight during use.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of a crutch free air boot accessory device of the present invention in accordance with the disclosed architecture;

FIG. 2 illustrates a perspective view showing the air boot accessory attached to an air boot in accordance with one embodiment of the present invention;

FIG. 3 illustrates a perspective view showing another embodiment of the air boot accessory device with integrated weight indicator in accordance with the disclosed structure;

FIG. 4 illustrates an enlarged view of the dial weight indicator used in the mobility aid accessory of the present invention showing weight calibration in accordance with the disclosed structure;

FIG. 5 illustrates a perspective view showing an adjustable rotating forearm style crutch handle attached to the accessory device of the present invention in accordance with one embodiment of the present invention; and

FIG. 6 illustrates a user using the air boot accessory device of the present invention in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a mobility aid that eliminates the challenges and discomfort associated with traditional crutches. Specifically, there is a long-felt need for a device that reduces the strain and pain in the upper body and underarm areas caused by crutch use. Additionally, there is a need for a mobility solution that enables for precise weight regulation on an injured limb. Furthermore, there exists a long-felt need for a device that enables users to retain at least one free hand, enabling them to carry items or perform daily tasks with greater case. Also, there is a long-felt need in the art for a walking boot attachment device that replaces crutches and provides a much more efficient and effective support for individuals with injured extremities. Finally, there is a need for a mobility aid that integrates with existing orthopedic walking boots, enhances stability and user confidence while minimizing the risk of additional injuries during recovery. The device is unlike any other mobility aid on the market as it is compact to easily enter and exit a transportation vehicle, such as car, airplane, etc. Further, the device allows a user to move in areas where mobility is typically restrictive.

The present invention, in one exemplary embodiment, is a mobility accessory device for use with an orthopedic walking boot. The device includes a cane receiving member configured for removable attachment to the walking boot using a clip mechanism, a telescoping cane having a top ergonomic handle and a bottom end, the cane is lockable at a user-defined height using a spring button locking mechanism within the cane receiving member, an air shock relief member for reducing impact during movement, and a weight calibration mechanism comprising a dial weight indicator and a gauge needle for setting and monitoring applied weight on the cane.

Reference will now be made in detail to the present preferred embodiments of the invention, examples of which are illustrated in the accompanying drawings. Wherever possible, the same reference numerals are used in the drawings and the description to refer to the same or like parts.

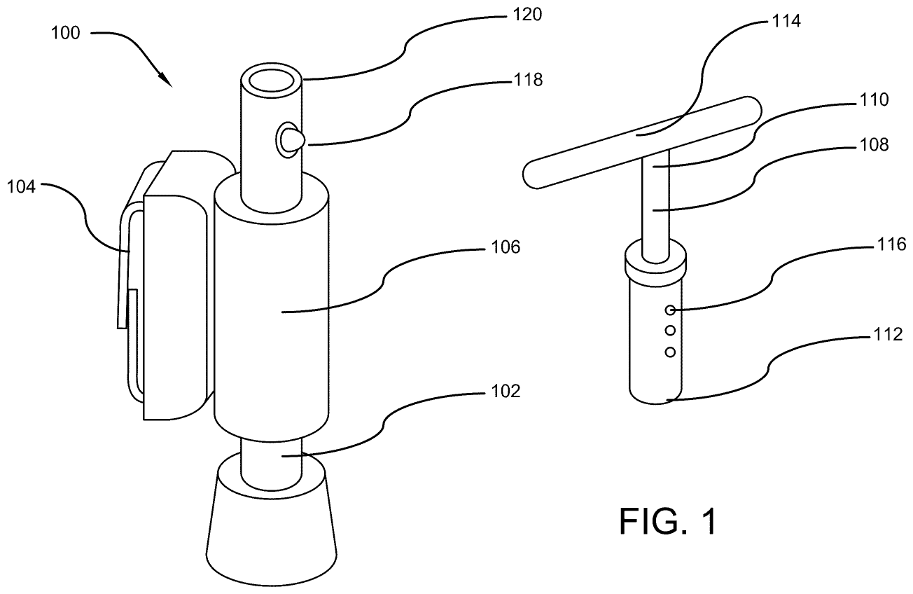

Referring initially to the drawings, FIG. 1 illustrates a perspective view of crutch free air boot accessory device of the present invention in accordance with the disclosed architecture. The air boot accessory 100 of the present invention is designed to integrate or removably attach to conventional and existing orthopedic walking boots for enhancing user independence by eliminating the need for traditional crutches. The mobility aid accessory 100 offers a more user-friendly and supportive recovery experience for individuals with leg, ankle, or foot injuries. More specifically, the accessory 100 includes a cane receiving member 102 made from a lightweight and durable material. The cane receiving member 102 includes a clip member 104 configured to removably attach the accessory 100 to an air boot. The clip member 104 is integrated to a slip-resistant cylindrical member 106 which circumscribes at least a portion of the cane receiving member 102.

The cane receiving member 102 is configured to receive and accommodate a cane or pole 108. The cane 108 has a top end 110 and an opposite (i.e., opposing) bottom end 112. An ergonomic handle 114 is disposed on the top end 110 for a comfortable grip by a user who is using the accessory device 100. A plurality of apertures 116 are disposed along a length of the cane or pole 108 and each aperture is dimensioned to engage to a spring button locking member 118 disposed near the top end 120 of the cane receiving member 102. The diameter of the cane 108 is sized to be inserted into the hollow cane receiving member 102 and the spring button locking member 118 engages to at least one aperture from the plurality of apertures 116 for locking and securing the cane 108 at a specific height. When the cane 108 and cane receiving member 102 are locked, the cane 108 does not slide inside the cane receiving member 102.

An air shock relief 120 is disposed along a length of the cane 108 and is configured to absorb shock during movement. The air shock relief 120 along with the spring button locking member 118 also helps in adjustment of the cane receiving member 102 as per height and requirements of a user.

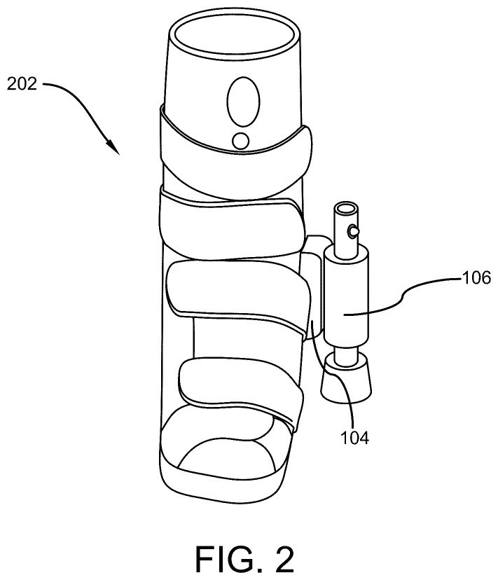

FIG. 2 illustrates a perspective view showing the air boot accessory attached to an air boot in accordance with one embodiment of the present invention. As illustrated, the clip member 104 is attached to the air or walking boot 202 (to a bottom clip of the air boot) for enabling a user to use the cane 108 for walking and movement and thereby eliminating use of crutches. The telescoping nature of the cane 108 enables the user to customize the cane's height for ergonomic use.

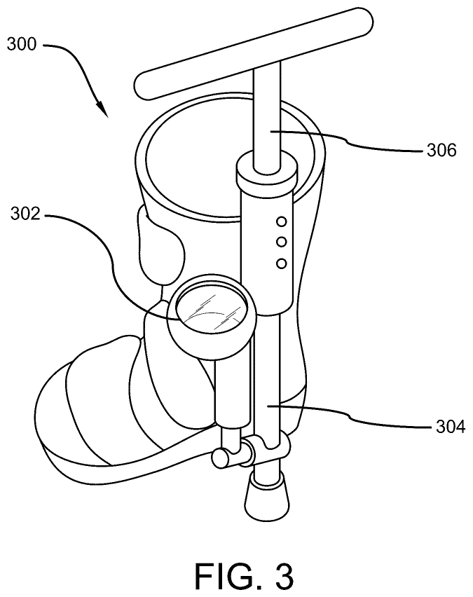

FIG. 3 illustrates a perspective view showing another embodiment of the air boot accessory device with integrated weight indicator in accordance with the disclosed structure. In the present embodiment, the mobility aid device 300 includes a dial weight indicator or gauge 302 integrated to the cane receiver 304. The dial weight indicator or gauge 302 is configured to measure and display the weight applied by a user on the cane 306. The dial weight indicator device 302 helps users and medical professionals to monitor progress and adjust weight distribution as the injury of the user using the air boot accessory device 300 heals. Specifically, when the user applies downward force on the cane 306, the indicator or gauge 302 indicates the applied force and guides the user to distribute weight appropriately between the boot and the cane.

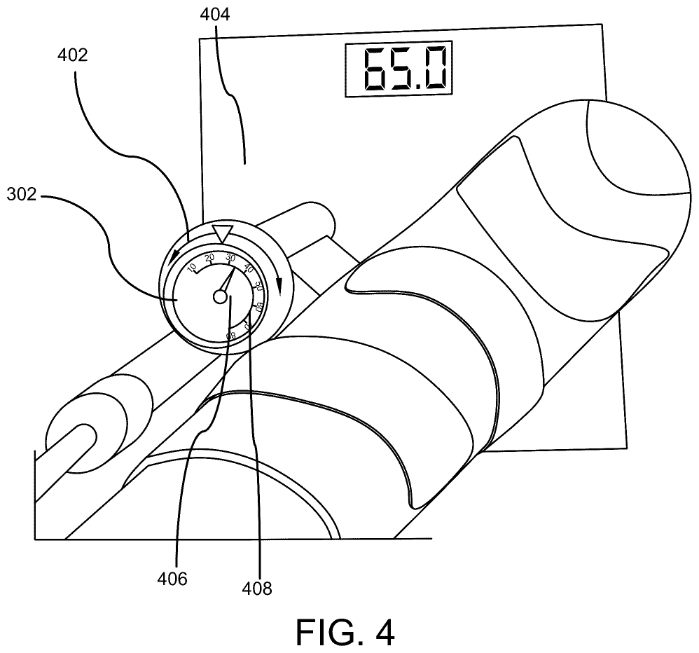

FIG. 4 illustrates an enlarged view of the dial weight indicator used in the mobility aid accessory of the present invention showing weight calibration in accordance with the disclosed structure. The dial weight indicator or gauge 302 includes a rotating adjustment dial 402 for enabling a user to perform weight calibration and setting a weight threshold to be applied on the cane of the accessory. For calibration of the indicator or gauge 302, a user wearing the air or walking boot 202 and using the telescoping air boot accessory 300, stands on a weighing scale 404, and a medical professional or user, using the rotating adjustment dial 302, configures the indicator or gauge 302. A gauge needle 406 visually displays the weight calibration and the gauge needle 406 can be set to any weight value from the plurality of weight values 408 displayed by the indicator device 302. In the preferred embodiment, users adjust the cane by placing the cane on a scale and applying downward force to measure a portion of their body weight minus, for example, the doctor-prescribed weight limit.

It should be noted that different types of attachments can be attached to the cane receiver of different embodiments of the present invention to accommodate requirements of different users.

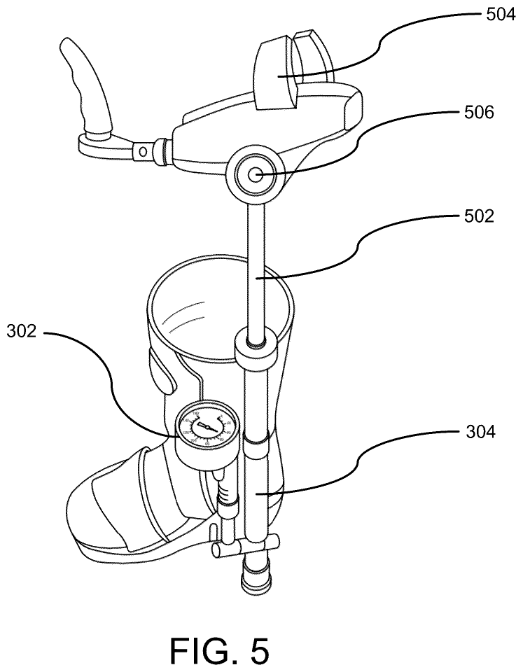

FIG. 5 illustrates a perspective view showing an adjustable rotating forearm style crutch handle attached to the accessory device of the present invention in accordance with one embodiment of the present invention. For individuals who cannot grip a cane easily or who need elbow support, a forearm style crutch 502 can be removably used with the cane receiver 102 or 304. The crutch 502 includes a rotating forearm support 504 which rotates along the pivoting joint 506. The force applied by the user on the crutch 502 can be measured and monitored by the dial weight indicator or gauge 302 in the manner described in FIG. 3.

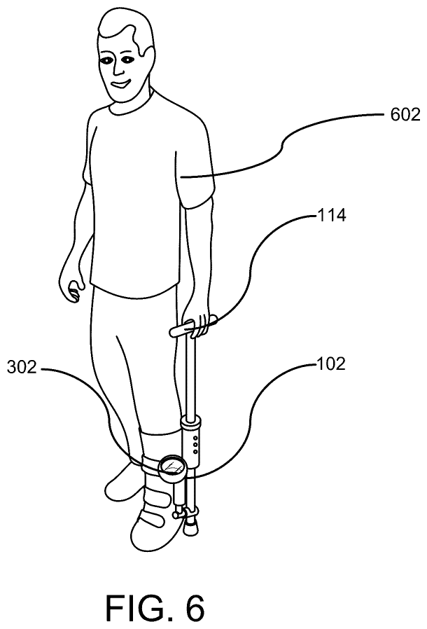

FIG. 6 illustrates a user using the air boot accessory device of the present invention in accordance with the disclosed structure. As illustrated, the user 602 can wear the air or walking boot 202 while the adjustable mobility aid device for orthopedic walking boots 100 is clipped to or integrated to the air or walking boot 202. The cane 306 can be adjusted as per height of the user 602 and the dial weight indicator device 302 is pre-calibrated as per weight of the user. The user 602 can easily walk by holding the cane or any other attached attachment as described in FIG. 5, thereby eliminating use and reliance on crutches.

The accessory device of different embodiments enables users to apply safe and accurate weight pressure on the cane, aiding in gradual recovery. The weight indicator dial provides immediate feedback to users, enabling them to adjust pressure and force on the cane and adhere to prescribed weight limits for optimal recovery. The cane and cane receiver are preferably made of stainless steel and the clip member 104 preferably connects securely to a low-profile boot clip. Further, the device helps users maintain doctor-recommended weight-bearing limits.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “adjustable mobility aid device for orthopedic walking boots”, “telescoping air boot accessory”, “crutch free air boot accessory device”, and “air boot accessory” are interchangeable and refer to the orthopedic walking boot mobility aid accessory 100 of the present invention.

Notwithstanding the forgoing, the orthopedic walking boot mobility aid accessory 100 of the present invention can be of any suitable configuration as is known in the art without affecting the overall concept of the invention, provided that it accomplishes the above stated objectives. One of ordinary skill in the art will appreciate that the orthopedic walking boot mobility aid accessory 100 as shown in the FIGS. are for illustrative purposes only, and that many other configurations of the orthopedic walking boot mobility aid accessory 100 are well within the scope of the present disclosure. Although the dimensions of the orthopedic walking boot mobility aid accessory 100 are important design parameters for user convenience, the orthopedic walking boot mobility aid accessory 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A walking boot cane accessory comprising:
a cane having a top end and an opposing bottom end;
a cane receiving member;
a clip member; and
a cylindrical member;
wherein said clip member removably attached to a walking boot;
wherein said clip member connected to said cylindrical member;
wherein said cylindrical member circumscribes at least a portion of said cane receiving member;
wherein said cane receiving member receives said cane therethrough;
wherein said top end of said cane having a handle for gripping by a user;
wherein said cane is a telescoping cane having a plurality of apertures; and
further wherein each aperture of said plurality of apertures selectively engageable with a spring locking member of said cane receiving member for adjusting a height of said cane relative to the walking boot.

2. The walking boot cane accessory of claim 1, wherein said spring locking member locks selectively with one of said plurality of apertures for locking a height of said cane.

3. The walking boot cane accessory of claim 1, wherein said cane receiving member having an air shock along a length of said cane for absorbing shock during movement of the walking boot cane accessory.

4. The walking boot cane accessory of claim 1, wherein said cane having an indicator gauge for measuring and displaying a weight applied by the user to said cane.

5. The walking boot cane accessory of claim 4, wherein said indicator gauge having an adjustment dial for setting a weight threshold applied to said cane.

6. The walking boot cane accessory of claim 5, wherein said handle having a rotating forearm support for supporting the user's forearm.

7. The walking boot cane accessory of claim 6, wherein said indicator gauge having a gauge needle for visually displaying said weight.

8. A walking boot cane accessory comprising:
a cane having a top end and an opposing bottom end;
a cane receiving member;
a clip member; and
a cylindrical member;
wherein said clip member removably attached to a walking boot;
wherein said clip member connected to said cylindrical member;
wherein said cylindrical member circumscribes at least a portion of said cane receiving member;
wherein said cane receiving member receives said cane therethrough;
wherein said top end of said cane having a handle for gripping by a user;
wherein said cane is a telescoping cane having a plurality of apertures;
wherein said cane having an indicator gauge for measuring and displaying a weight applied by the user to said cane; and
further wherein said indicator gauge having an adjustment dial for setting a weight threshold applied to said cane.

9. The walking boot cane accessory of claim 8, wherein said cane receiving member having an air shock along a length of said cane for absorbing shock during movement of the walking boot cane accessory.

10. The walking boot cane accessory of claim 8, wherein each aperture of said plurality of apertures selectively engageable with a spring locking member of said cane receiving member for adjusting a height of said cane relative to the walking boot.

11. The walking boot cane accessory of claim 10, wherein said spring locking member locks selectively with one of said plurality of apertures for locking a height of said cane.

12. The walking boot cane accessory of claim 11, wherein said handle having a rotating forearm support for supporting the user's forearm.

13. The walking boot cane accessory of claim 8, wherein said indicator gauge having a gauge needle for visually displaying said weight.

14. A walking boot cane accessory comprising:
a cane having a top end and an opposing bottom end;
a cane receiving member;
a clip member; and
a cylindrical member;
wherein said clip member removably attached to a walking boot;
wherein said clip member connected to said cylindrical member;
wherein said cylindrical member circumscribes at least a portion of said cane receiving member;
wherein said cane receiving member receives said cane therethrough;
wherein said top end of said cane having a handle for gripping by a user; and
further wherein said handle having a rotating forearm support for supporting the user's forearm.

15. The walking boot cane accessory of claim 14, wherein said cane is a telescoping cane having a plurality of apertures, and further wherein each aperture of said plurality of apertures selectively engageable with a spring locking member of said cane receiving member for adjusting a height of said cane relative to the walking boot.

16. The walking boot cane accessory of claim 15, wherein said spring locking member locks selectively with one of said plurality of apertures for locking a height of said cane.

17. The walking boot cane accessory of claim 14, wherein said cane receiving member having an air shock along a length of said cane for absorbing shock during movement of the walking boot cane accessory.

18. The walking boot cane accessory of claim 16, wherein said cane having an indicator gauge for measuring and displaying a weight applied by the user to said cane.

19. The walking boot cane accessory of claim 18, wherein said indicator gauge having an adjustment dial for setting a weight threshold applied to said cane.

20. The walking boot cane accessory of claim 19, wherein said indicator gauge having a gauge needle for visually displaying said weight.
